(19) United States
(12) Patent Application Publication
(10) Pub. No.: US 2013/0083513 A1
(43) Pub. Date: Apr. 4, 2013

(54) LIGHT SOURCE UNIT, BACKLIGHT UNIT, AND FLAT PANEL DISPLAY DEVICE

(71) Applicants: Hirohisa Saito, Osaka-shi (JP); Hideki Matsubara, Osaka-shi (JP); Yoshihiro Akahane, Osaka-shi (JP)

(72) Inventors: Hirohisa Saito, Osaka-shi (JP); Hideki Matsubara, Osaka-shi (JP); Yoshihiro Akahane, Osaka-shi (JP)

(73) Assignee: SUMITOMO ELECTRIC INDUSTRIES, LTD., Osaka-shi, Osaka (JP)

(21) Appl. No.: 13/704,597

(22) PCT Filed: Jun. 6, 2011
(86) PCT No.: PCT/JP2011/062980

§ 371 Date: Dec. 14, 2012

(30) Foreign Application Priority Data
Oct. 5, 2010 (JP) 2010-225906

(51) Int. Cl. F21S 2/00; G02F 1/133; F21V 21/00

(52) U.S. Cl. CPC F21S 2/00; F21V 21/00; G02F 1/133
USPC 362/97.2; 362/249.13; 362/249.05; 362/97.1

(57) ABSTRACT

A light source unit (100) switches one or more of light source groups (P, Q, R), each comprising one or more of light sources (110), ON and OFF for each light source group or each light source. The light source unit (100) includes: a flexible printed wiring board (120); one or more of light source groups (P, Q, R) mounted on a first surface of the flexible printed wiring board (120); and a metal support plate (130) attached to a second surface on the opposite side to the first surface of the flexible printed wiring board (120) via an adhesive layer (140). The heat conductivity of the adhesive layer (140) in the vertical direction is set so as to be less than the heat conductivity in a base material layer (121) of the flexible printed wiring board (120) in the vertical direction.

### TECHNICAL FIELD

The present invention relates to a light source unit, a backlight unit having the light source unit, and a flat panel display apparatus having the backlight unit.

### BACKGROUND ART

Conventionally, cold cathode fluorescent lamps (hereinafter, referred to as CCFLs), which have high brightness and are inexpensive, have been employed in backlight units for liquid crystal display devices. However, recent development in light emitting diodes (LEDs) has improved brightness and decreased the cost for the LEDs. As a result, more CCFLs, which disadvantageously contain mercury, are now being replaced by the LEDs.

Initially, in a backlight unit for a liquid crystal display apparatus using LEDs, the LEDs were constantly illuminated and a liquid crystal shutter was employed to adjust colors and brightness, as in the case of the CCFLs. However, to decrease power consumption and create the pitch black color for improved color reproducibility, more cases now perform local ON/OFF control on the LEDs, which is local dimming.

The term “local dimming” refers to the technique in which the light exit surface of a backlight unit is divided into multiple zones and light intensity is controlled separately for the respective zones in correspondence with an image to display.

The light emitting efficiency of an LED decreases as the temperature rises. To avoid a temperature rise, a conventional backlight unit employing constantly illuminated LEDs is formed using material with improved heat conductivity to maintain the LEDs at a low temperature. In other words, by improving heat dissipation characteristics for the respective LEDs, a temperature rise is prevented equally in the LEDs. The LEDs are thus actuated with uniform light emitting efficiencies.

In a backlight unit performing the local dimming, the LEDs are subjected to local ON/OFF control. This leads to a low temperature in those of the LEDs that have been maintained in an OFF state, compared to the other LEDs, which have been maintained in an ON state. Accordingly, if equal electric currents are supplied to the LEDs to obtain equal brightness in light emission from the LEDs that have been maintained in the OFF state and the other LEDs, which have been maintained in the ON state, the light emitted from the LEDs that have been maintained in the OFF state becomes brighter than the other LEDs. This results in varying brightness of the LEDs, which is disadvantageous.

For example, Patent Documents 1 and 2 disclose a backlight unit employing such LEDs as a backlight.

### PRIOR ART DOCUMENTS

### Patent Documents

Patent Document 1: Japanese Laid-Open Patent Publication No. 2004-214094

Patent Document 1: Japanese Laid-Open Patent Publication No. 2005-135862

### SUMMARY OF THE INVENTION

### Problems that the Invention is to Solve

The invention described in Patent Document 1 is related to a backlight apparatus and a liquid crystal display apparatus. The apparatuses are advantageous in that they save costs, improve efficiency for guiding light from a light source to a light guide panel, and enhance heat dissipating effects of the light source.

The invention described in Patent Document 2 relates to a light unit. The light unit advantageously ensures bright and desirable display on a display panel through efficient light introduction from a light source to a light guide panel and radiation of the light on the display panel via the light guide panel.

However, neither the backlight apparatus in Patent Document 1 nor the light unit in Patent Document 2 employs local dimming. There is thus no description or suggestion made by Patent Document 1 or 2 that may be capable of solving the problem of the local dimming, which is the varying brightness in the LEDs.

Accordingly, it is an objective of the present invention to provide a light source unit employing local dimming capable of ensuring uniform brightness in the light source groups and improved heat dissipation performance, a backlight unit having the light source unit, and a flat panel display apparatus including the backlight unit.

### Means for Solving the Problems

In accordance with a first aspect of the present invention, a light source unit is provided that includes one or more groups of light sources. Each of the light source groups is configured by one or more light sources. The light source unit performs ON/OFF control separately on the respective light source groups or on the respective light sources. The light source unit further includes a flexible printed wiring board and a metal support plate. The flexible printed wiring board is formed by laminating one or more conductive layers on a flexible base material layer. The flexible printed wiring board has a first surface and a second surface located at the opposite side to the first surface. The light source groups are mounted on the first surface of the flexible printed wiring board. The metal support plate is attached to the second surface of the flexible printed wiring board with an adhesive layer. The metal support plate is a base of the light source unit. The heat conductivity in the adhesive layer in the vertical direction is lower than a heat conductivity in the base material layer of the flexible printed wiring board in the vertical direction.

In this configuration, when the heat produced by the light source units in operation is transferred to the metal support plate through the flexible printed wiring board, the heat conduction from the flexible printed wiring board and the metal support plate is decreased. As a result, the heat generated by the light source groups in operation is diffused sufficiently in the flexible printed wiring board before being conducted to the metal support plate. This decreases unevenness in the temperature distribution in the flexible printed wiring board and ensures gradual conduction of the heat to the metal support plate.

As a result, the heat conducted from the light source groups to the flexible printed wiring board is distributed evenly in the flexible printed wiring board and gradually dissipated into the metal support plate.

Accordingly, the above-described configuration ensures uniform brightness in the light source groups and improved heat dissipation performance in the light source unit employing local dimming.

For any one of the light source groups including a plurality of light sources, it is preferable that the respective light sources can be subjected to the ON/OFF control separately from one light source to another.

This configuration ensures illumination with improved flexibility, thus achieving a wider variety of illumination.

The heat conductivity in the adhesive layer in the vertical direction is preferably set to 30 to 80% of the heat conductivity in the base material layer of the flexible printed wiring board in the vertical direction.

This configuration further efficiently ensures uniform brightness in the light source groups and improved heat dissipation performance.

Each of the light sources preferably includes a light emitting diode.

This configuration ensures uniform brightness in the light source groups, each of which includes the light emitting diode, and improved heat dissipation performance. The configuration also prevents decrease of the light emitting efficiency of each light emitting diode caused by a temperature rise and brings about a highly energy-saving and long-life light source unit.

The conductive layers are preferably formed by a plurality of copper film layers, and at least one of the conducive layers is preferably electrically disconnected from the other components and functions as a heat diffusion layer for diffusing heat produced by the light sources in operation into the flexible printed wiring board.

In this configuration, the heat conducted from the light source groups into the flexible printed wiring board is evenly distributed in the flexible printed wiring board with enhanced efficiency.

In accordance with a second aspect of the present invention, a backlight unit is provided that uses the light source unit of the above first aspect.

This configuration brings about a backlight unit that ensures uniform brightness in the light source groups and improved heat dissipation performance.

In accordance with a third aspect of the present invention, a flat panel display apparatus is provided that uses the backlight unit of the second aspect.

This configuration brings about a flat panel display apparatus that ensures uniform brightness in the light source groups and improved heat dissipation performance.

### Effects of the Invention

The light source unit according to the present invention, the backlight unit including the light source unit, and the flat panel display apparatus having the backlight unit ensure uniform brightness in light source groups and improved heat dissipation performance in a light source unit performing local dimming.

### BRIEF DESCRIPTION OF THE DRAWINGS

FIG. 1 is a perspective view showing a backlight unit as a whole according to one embodiment of the present invention;

FIG. 2(a) is a longitudinal cross-sectional view showing the light source unit in FIG. 1;

FIG. 2(b) is a transverse cross-sectional view showing the light source unit in FIG. 1;

FIG. 3(a) is a diagram illustrating heat transfer in a conventional light source unit;

FIG. 3(b) is a diagram illustrating heat transfer in the light source unit according to the embodiment of the invention;

FIG. 4(a) is a transverse cross-sectional view showing a light source unit of a first modification according to the invention;

FIG. 4(b) is a transverse cross-sectional view showing a light source unit of a second modification according to the invention; and

FIG. 5 is a transverse cross-sectional view showing a light source unit of a third modification according to the invention.

### MODES FOR CARRYING OUT THE INVENTION

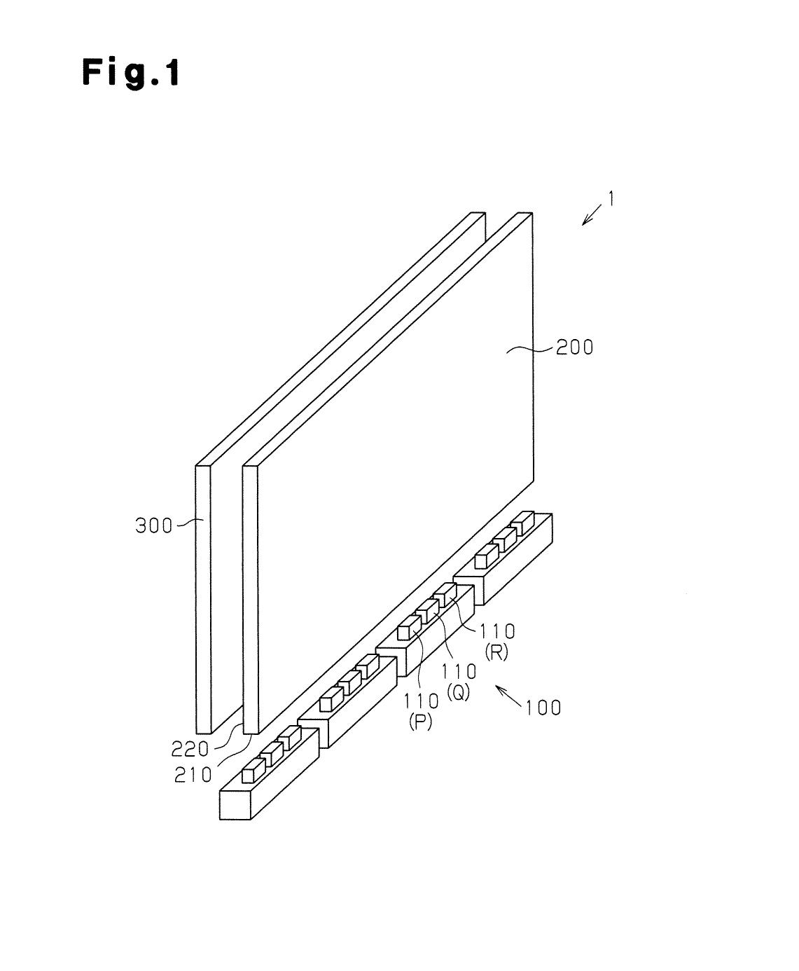

With reference to FIGS. 1, 2, and 3, a light source unit 100 according to one embodiment of the present invention, a backlight unit 1 having the light source unit 100, and a flat panel display apparatus with the backlight unit 1 will now be described. The description below simply illustrates a certain embodiment of the invention and does not restrict the scope of the claims.

As shown in FIG. 1, the backlight unit 1, which includes four light source units 100 and a light guide panel 200, is arranged at the back of a liquid crystal display 300. The light guide panel 200 faces the backside of the liquid crystal display 300 and emits light onto the liquid crystal display 300. Each of the light source units 100 is a side light type, which sends light into the light guide panel 200 through the lower end surface of the light guide panel 200.

The light source units 100 and the light guide panel 200 configure the backlight unit 1, which emits light onto the backside of the liquid crystal display 300. A non-illustrated flat panel display apparatus, which display various types of images, is configured mainly by the backlight unit 1 and the liquid crystal display 300.

Each of the light source units 100 has a plurality of light source groups each configured by one or more light sources. Each light source unit 100 employs local dimming, or, in other words, performs ON/OFF control separately on the respective light source groups.

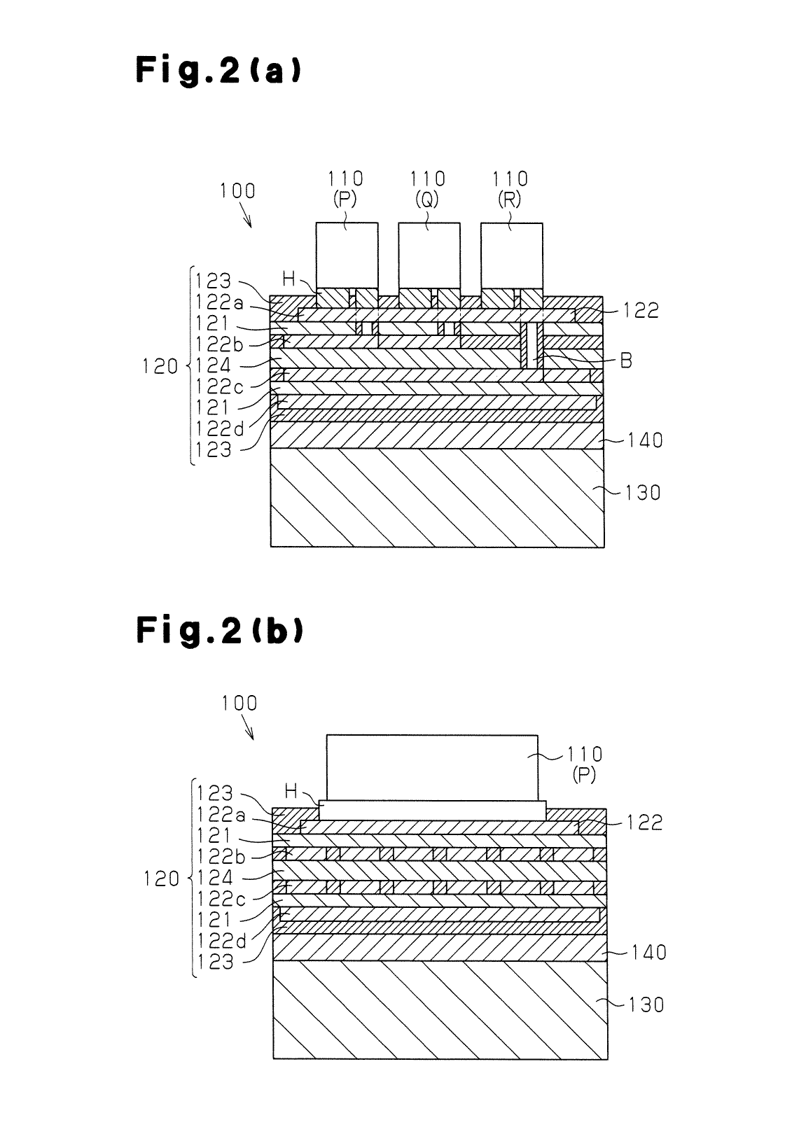

As illustrated in FIG. 2, each light source unit 100 includes light sources 110, a flexible printed wiring board 120, a metal support plate 130, and an adhesive layer 140.

The light sources 110 are mounted on the upper surface (a first surface) of the flexible printed wiring board 120 with solder H and emit light onto the light guide panel 200. In the illustrated embodiment, LEDs are employed as the light sources 110.

By using the LEDs as the light sources 110, each light source unit 100 is allowed to conserve more energy and prolong its life.

The light sources 110 form light source groups, each of which includes one or more light sources. Each of the light source groups is subjected to ON/OFF control independently from other light source groups by a non-illustrated control section.

In the illustrated embodiment, as illustrated in FIGS. 1 and 2, the three light source groups P, Q, R, each of which includes a single light source 110, form one light source unit 100. With reference to FIG. 1, the four light source units 100 are arranged to face the lower end surface of the light guide panel 200.

The numbers and the configurations including locations of the light source units 100 facing the lower end surface of the light guide panel 200, the light source groups forming each light source unit 100, and the light sources 110 forming each light source group are not restricted to those of the illustrated embodiment but may be changed as necessary.

The flexible printed wiring board 120 electrically connects the light sources 110 to non-illustrated external wires and dissipates the heat generated by the light source groups P, Q, R in operation.

Specifically, the flexible printed wiring board 120 is a multilayer board. The flexible printed wiring board 120 is formed by bonding two double-sided flexible printed wiring boards each having conductive layers formed on opposite surfaces of the board.

As shown in FIG. 2, the flexible printed wiring board 120 includes a base material layer 121, a conductive layer 122, a cover layer 123, and an adhesive layer 124.

The base material layer 121 is the base of the flexible printed wiring board 120 and formed using an insulating plastic film.

As the plastic film, a film formed of soft plastic is used. Specifically, the plastic film may be any suitable plastic film such as a polyimide film or a polyester film, as long as the film is normally used as a plastic film for forming a flexible printed wiring board.

Particularly, it is preferable that the plastic film be not only soft but also highly heat-resistant. For example, a polyamide-based plastic film, a polyimide-based plastic film such as a polyimide or polyamide-imide plastic film, or a polyethylene naphthalate plastic film may be preferably employed.

The heat-resistant plastic may be any suitable heat-resistant plastic such as polyimide resin or epoxy resin, as long as the material is normally employed as heat-resistant plastic used to form a flexible printed wiring board. More preferably, to form the base material layer 121, it is preferable to use material that ensures heat conductivity of approximately 0.12 W/mK in the base material layer 121 in the vertical direction.

It is preferable that the thickness of the base material layer 121 be approximately 5 to 100 μm.

The conductive layer 122 functions a circuit wiring layer including circuit wiring for electrically connecting the light sources 110 to the external wires and separately controlling the light source groups and a heat diffusion layer for diffusing the heat produced by the light source groups P, Q, R in operation into the flexible printed wiring board 120.

The conductive layer 122 is formed using conductive metal films. In the illustrated embodiment, two double-sided flexible printed wiring boards are bonded together to form the conductive layer 122, which has a four layer structure, referring to FIG. 2.

Specifically, a first conductive layer 122a, a second conductive layer 122b, and a third conductive layer 122c each function as a circuit wiring layer. A fourth conductive layer 122d functions as a heat diffusion layer. More specifically, the first conductive layer 122a functions as a common cathode circuit wiring layer. The second conductive layer 122b and the third conductive layer 123c each function as an anode circuit wiring layer for controlling the light source groups P, Q, R. The fourth conductive layer 122d is electrically disconnected from the other components and functions as the heat diffusion layer, which diffuses the heat generated by the light source groups P, Q, R in operation into the flexible printed wiring board 120.

With reference to FIG. 2(a), each light source 110 has a non-illustrated electrode electrically connected to the first conductive layer 122a. The electrode is also electrically connected to the second conductive layer 122b and the third conductive layer 122c with the solder H. Such non-illustrated electrodes of the light sources 110 are electrically connected together through the solder H and a blind via B.

The first to fourth conductive layers 122a to 122d are formed using a conventional method such as etching on the conductive layer 122.

In the illustrated embodiment, the conductive metal films are formed of copper (Cu). However, the material of the conductive metal films is not restricted to the copper (Cu) but may be any suitable metal as long as the metal is normally used as a conductive metal film for forming a conductive layer in a flexible printed wiring board.

It is preferable that the thickness of the conductive layer 122 be approximately 35 μm.

The cover layer 123 forms an insulating layer for the flexible printed wiring board 120. The cover layer 123 is formed by, for example, bonding a cover layer film to the base material layer 121 and the conductive layer 122 with non-illustrated cover layer adhesive, which is, for example, thermosetting adhesive. The cover layer 123 has through holes for receiving the solder H, which are formed at the positions corresponding to the light sources 110.

As the cover layer, a polyimide film or a photosensitive resist or a liquid resist may be used.

It is preferable that the thickness of the cover layer 123 be approximately 5 to 100 μm.

The adhesive layer 124 is used to bond the two double-sided flexible printed wiring boards together.

As adhesive, an imide or epoxy based adhesive may be employed. The adhesive may be in the form of a sheet or gel, or, in other words, any suitable form of adhesive that is normally used to form a multilayer board including a plurality of bonded flexible printed wiring boards.

It is preferable that the thickness of the adhesive layer 124 be approximately 5 to 100 μm.

In the illustrated embodiment, the flexible printed wiring board 120, which is a multilayer board, is configured by bonding the two flexible printed wiring boards with the adhesive layer 124. However, the configuration of the flexible printed wiring board 120 is not restricted to that of the embodiment but may be modified as needed.

The number of layers or the location of the conductive layer 122 and the number of layers or the location of the heat diffusion layer are not restricted to those in the illustrated embodiment but may be modified as necessary.

The metal support plate 130 is attached to the lower surface (a second surface) of the flexible printed wiring board 120, which is opposite to the upper surface on which the light source groups P, Q, R are mounted, with the adhesive layer 140. The metal support plate 130 serves as the bases of the light source units 100 and dissipates the heat produced by the light source groups P, Q, R in operation.

In the illustrated embodiment, aluminum (Al) is used as the material of the metal support plate 130. However, the material of the metal support plate 130 is not restricted to aluminum (Al) but may be any suitable material normally used as a metal support board configuring a light source unit.

It is preferable that the thickness of the metal support plate 130 be approximately 3 mm.

The adhesive layer 140 bonds the flexible printed wiring board 120, on which the light sources 110 are mounted, with the metal support plate 130.

In the illustrated embodiment, the heat conductivity in the adhesive layer 140 in the vertical direction is lower than the heat conductivity in the base material layer 121 of the flexible printed wiring board 120 in the vertical direction. Specifically, the heat conductivity in the adhesive layer 140 in the vertical direction is 30 to 80% of the heat conductivity in the base material layer 121 of the flexible printed wiring board 120 in the vertical direction.

As adhesive, epoxy or acrylic based adhesive may be employed. It is preferable to form the adhesive layer 140 using epoxy or acrylic based adhesive exhibiting heat conductivity of approximately 0.01 to 1 W/mK in the adhesive layer 140 in the vertical direction.

It is preferable that the thickness of the adhesive layer 140 be approximately 30 μm.

This configuration suppresses heat conduction between the flexible printed wiring board 120 and the metal support plate 130 when the heat produced by the light source groups P, Q, R in operation is transferred to the metal support plate 130 through the flexible printed wiring board 120.

Before being conducted to the metal support plate 130, the heat generated by the light source groups P, Q, R in operation is diffused sufficiently in the flexible printed wiring board 120. This decreases unevenness in temperature distribution in the flexible printed wiring board 120 and, meanwhile, ensures gradual conduction of the heat into the metal support plate 130.

As a result, the heat conducted from the light source groups P, Q, R into the flexible printed wiring board 120 is distributed uniformly in the flexible printed wiring board 120 and gradually dissipated into the metal support plate 130.

Accordingly, in each light source unit 100 performing the local dimming, uniform brightness is ensured for the light source groups P, Q, R and the heat dissipation performance is improved.

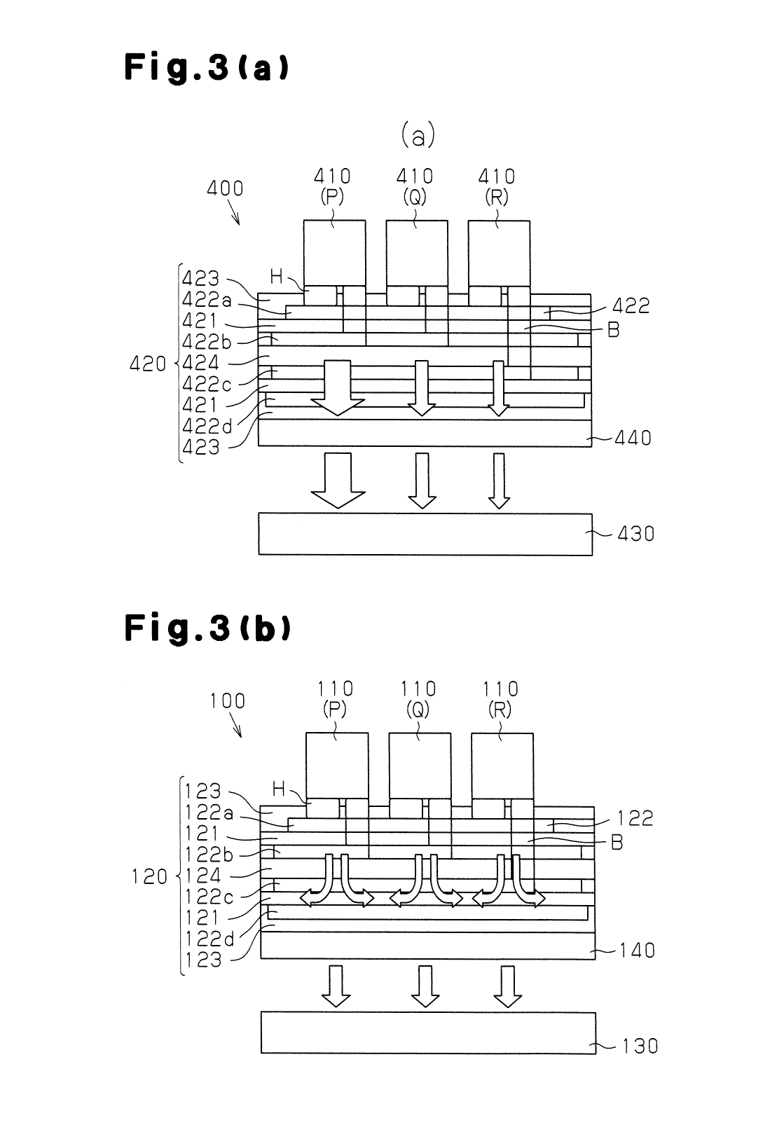

For comparison with the operation and effects of the illustrated embodiment, a conventional light source unit 400 will be described with reference to FIG. 3(a). The same or like reference indices are given to components of the light source unit 400 that are the same as or like corresponding components of the light source unit 100 of the embodiment in terms of configurations and functions. Description of these components is omitted herein.

Specifically, the light source unit 400 employs the local dimming. The heat conductivity in an adhesive layer 440 in the vertical direction is not lower than the heat conductivity in a base material layer 421 of a flexible printed wiring board 420 in the vertical direction. When it is assumed that the light source group P is ON and the light source groups Q, R are OFF in the light source unit 400, the heat generated by the light source group P in operation is transferred from a position immediately below the light source group P in the flexible printed wiring board 420 locally toward the metal support plate 430, as indicated by the corresponding arrows in FIG. 3(a).

This causes a high temperature in the zone immediately below the light source group P, which is ON, in contrast to a low temperature in the zones immediately below the light source groups Q, R, which are OFF, in the flexible printed wiring board 420. In other words, the temperature characteristics in the flexible printed wiring board 420 are varied from a position to another.

As a result, when the light source group R is switched from the OFF state to the ON state, the brightness in the light source unit 400 is varied. Specifically, to allow the light source group R to emit light with brightness equal to the brightness of the light source group P, which has been ON, equal electric currents are supplied to the light source group R and the light source group P. In this state, the temperature of the light source group R, which has been OFF, is comparatively low. As a result, the light source group R emits light with high brightness compared to the light source group P, thus causing variation in the brightness in the light source unit 400.

FIG. 3(b) shows the light source unit 100 according to the illustrated embodiment of the present invention, which also employs the local dimming. When the light source group P is ON and the light source groups Q, R are OFF, the heat produced by the light source group P in operation is prevented from being transferred from a position immediately below the light source group P locally toward the metal support plate 130, as indicated by the arrows in FIG. 3(b).

In other words, the heat produced by the light source group P in operation is sufficiently diffused in the flexible printed wiring board 120 before being conducted to the metal support plate 130. This decreases unevenness in the temperature distribution in the flexible printed wiring board 120 and ensures gradual conduction of the heat into the metal support plate 130.

As a result, the flexible printed wiring board 120 exhibits uniform temperature characteristics at any position. Accordingly, if equal electric currents are supplied to the light source group P, which has been ON, and the light source group R, which has been OFF, to emit light from the light source group R with brightness equal to that of the light source group P, the light source group R is prevented from emitting light with comparatively high brightness. The light source groups P, R thus have equal brightness.

As a result, each light source unit 100 is effectively prevented from having brightness variation caused by varying temperature characteristics.

FIG. 3 is similar to the cross-sectional view of FIG. 2(a). However, to effectively illustrate the heat transfer,

FIG. 3 are shown without hatching and the metal support plate 130 is illustrated as spaced from the flexible printed wiring board 120 in the drawings.

The fourth conductive layer 122d is electrically disconnected from the other components and serves as the heat diffusion layer for diffusing the heat generated by the light source groups in operation into the flexible printed wiring board 120. As a result, the heat conducted from the light source group P into the flexible printed wiring board 120 is distributed uniformly in the flexible printed wiring board 120 further efficiently.

Also, the heat produced by the light source group P in operation is conducted gradually into the metal support plate 130 and thus dissipated. This prevents the light emission efficiency of the LEDs from being decreased by a temperature rise.

As a result, in each light source unit 100 employing the local dimming, uniform brightness is ensured in the light source groups and the heat dissipation performance is improved.

Since the light source unit 100 is a side light type, which radiates the light into the light guide panel 200 through the lower end surface of the light guide panel 200, the thickness of the backlight unit 1 is decreased.

The light guide panel 200 guides the light from the light source unit 100 to the liquid crystal display 300 and thus radiates the light onto the liquid crystal display 300.

Specifically, referring to FIG. 1, the light emitted by the light source unit 100 is sent into the light guide panel 200 through a light incident end surface 210. The light exits a light exit end surface 220 to proceed toward the liquid crystal display 300, while being totally reflected in the light guide panel 200.

As the material of the light guide panel 200, any suitable material, such as plastic, may be employed as long as the material is normally used to form a light guide panel.

In the illustrated embodiment, the backlight unit 1 is configured only with the light source units 100 and the light guide panel 200. However, the backlight unit 1 is not restricted to this configuration. For example, any suitable component such as a reflection sheet or an optical sheet, which is normally employed as a component of a backlight unit, may be combined with the light source units 100 and the light guide panel 200 to configure the backlight unit 1.

The liquid crystal display 300 is a display device that generates an image on a flat panel display apparatus, which is not illustrated in detail.

The size and the configuration including the size of the liquid crystal display 300 are not restricted to those of the illustrated embodiment but may be changed as necessary.

In the illustrated embodiment, each light source unit 100 employing the local dimming is configured to perform ON-OFF control separately on the respective light source groups. Specifically, the light source unit 100 is configured by the three light source groups P, Q, R, each of which is formed by the single light source 110. The ON-OFF control is carried out separately for each of the light source groups P, Q, R. However, each light source unit 100 does not necessarily have to be configured in this manner.

For example, each light source unit employing the local dimming may include light source groups each having a plurality of light sources. The light sources in each light source group are connected in parallel. This allows separate execution of the ON-OFF control on not only the respective light source groups but also the respective light sources in each light source group. This ensures uniform brightness in the light source groups and the light sources in each of the light source groups and high heat dissipation performance in the light source unit employing the local dimming. This configuration also allows more flexible illumination, thus ensuring a wider variety of illumination.

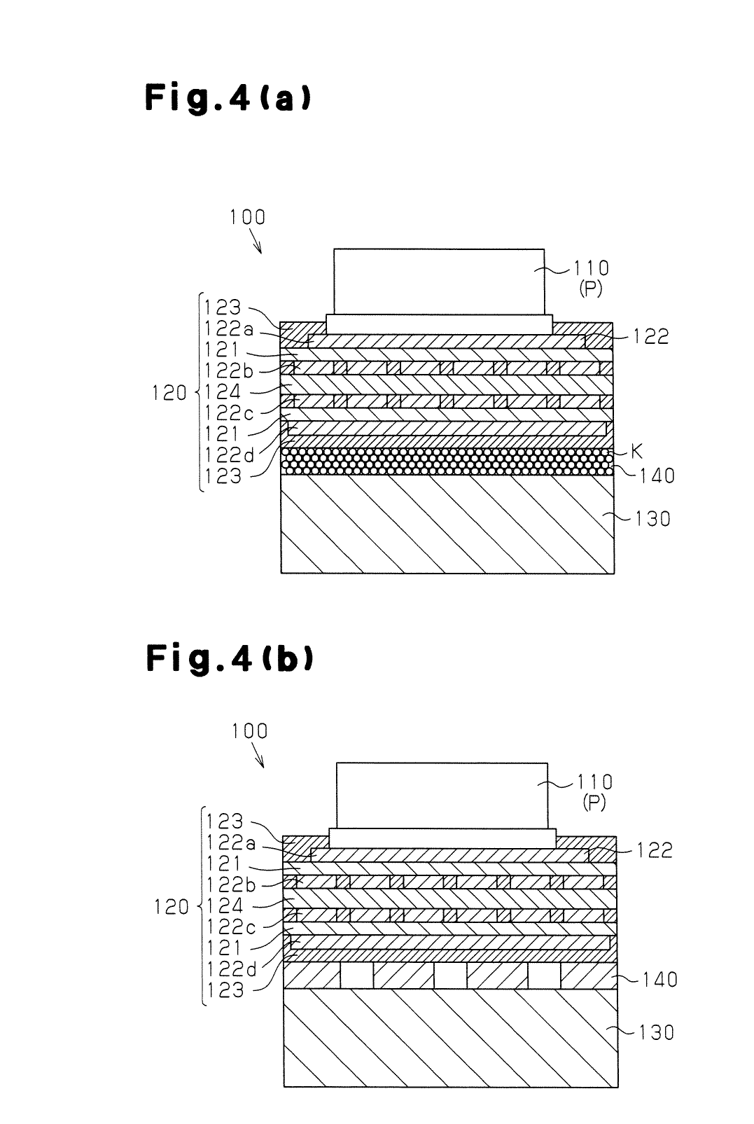

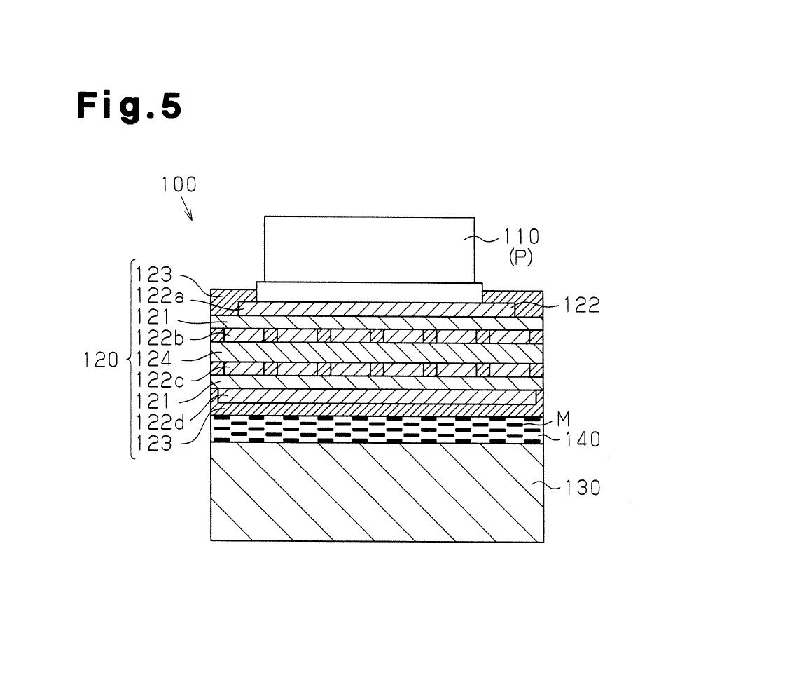

Next, with reference to FIGS. 4(a), 4(b), and 5, first to third modifications of the light source unit according to the illustrated embodiment of the present invention will be described.

In the first to third modifications, the configuration of the adhesive layer for bonding the flexible printed wiring board and the metal support plate is modified from that of the above illustrated embodiment. The configurations of the other components in the first to third modifications are identical to the configurations of the corresponding components of the illustrated embodiment. The same or like reference numerals are given to components of the first to third modifications that are the same as or like corresponding components of the embodiment in terms of configurations and functions. Description of these components is omitted herein.

The first modification of the light source unit according to the illustrated embodiment of the present invention will hereafter be described with reference to FIG. 4(a).

In the first modification, the adhesive layer 140 is formed using a highly heat conductive adhesive and foams (micro-bubbles) K are dispersed in the adhesive layer 140.

In this configuration, despite the fact that the highly heat conductive adhesive is used, the heat conductivity of the adhesive layer 140 as a whole in the vertical direction is lower than the heat conductivity of the base material layer 121 of the flexible printed wiring board 120 in the vertical direction. Specifically, the heat conductivity of the adhesive layer 140 as a whole in the vertical direction is 30 to 80% of the heat conductivity of the base material layer 121 in the vertical direction.

As a result, the heat conducted from the light source groups into the flexible printed wiring board 120 is uniformly distributed in the flexible printed wiring board 120 and gradually dissipated into the metal support plate 130.

The light source unit 100 employing the local dimming thus ensures uniform brightness in the light source groups and improves heat dissipation performance.

The second modification of the light source unit according to the illustrated embodiment of the present invention will hereafter be described with reference to FIG. 4(b).

In the second modification, the adhesive layer 140 is formed using a highly heat conductive adhesive. The adhesive is applied to separate positions between the flexible printed wiring board 120 and the metal support plate 130.

In this configuration, despite the fact that the highly heat conductive adhesive is used, the average heat conductivity of the adhesive layer 140 as a whole in the vertical direction is set to a value smaller than the heat conductivity of the base material layer 121 of the flexible printed wiring board 120 in the vertical direction. Specifically, the average heat conductivity of the adhesive layer 140 as a whole in the vertical direction is set to a value equal to 30 to 80% of the heat conductivity of the base material layer 121 in the vertical direction.

As a result, the heat conducted from the light source groups into the flexible printed wiring board 120 is uniformly distributed in the flexible printed wiring board 120 and gradually dissipated into the metal support plate 130.

Each light source unit 100 employing the local dimming thus ensures uniform brightness in the light source groups and improves heat dissipation performance.

The third modification of the light source unit according to the illustrated embodiment of the present invention will now be described with reference to FIG. 5.

In the third modification, the adhesive layer 140 is formed using adhesive having heat conductivity equal to 30 to 80% of the heat conductivity in the base material layer 121 in the vertical direction. Needle-like or flat-plate-like micro metal pieces M are aligned horizontally in the adhesive layer 140.

In this configuration, the heat generated by the light source groups in operation and transferred to the adhesive layer 140 is conducted horizontally in the adhesive layer 140 and thus diffused more effectively. As a result, heat conduction in the direction of the thickness of the adhesive layer 140 is prevented with improved efficiency. Also, the heat is more effectively prevented from being conducted locally toward the metal support plate 130.

As a result, the heat conducted from the heat source groups into the flexible printed wiring board 120 is distributed uniformly in the flexible printed wiring board 120 with enhanced efficiency and gradually dissipated into the metal support plate 130.

Each light source unit 100 employing the local dimming thus ensures uniform brightness in the light source groups and improves heat dissipation performance with improved efficiency.

The micro metal pieces M may be replaced by micro carbon pieces, such as carbon nanotubes or graphite pieces, which are aligned horizontally in the adhesive layer 140.

A graphite sheet may be arranged between the flexible printed wiring board 120 and the metal support plate 130.

The graphite sheet has higher heat conductivity in the horizontal direction than the vertical direction. Accordingly, in this configuration, the heat conducted from the light source groups to the metal support plate 130 through the flexible printed wiring board 120 is efficiently uniformly distributed in the flexible printed wiring board 120 and gradually dissipated into the metal support plate 130.

### EXAMPLE

The present invention will hereafter be described in further detail by means of an example. However, the invention is not restricted to the example.

As light source units for a 42-inch liquid crystal display apparatus, two light source units with the lateral width of 54 cm were aligned in the upward-downward direction. Each of the light source units included fifty-two LEDs as light sources. Every four LEDs were wired directly together to form a light source group and controlled collectively. The resulting thirteen light source groups were controlled separately from one group to another (by local dimming).

As a flexible printed wiring board, a multilayer board having four conductive layers, each of which was a copper film with the thickness of 35 μm, was prepared. The uppermost one of the conductive layers was a common cathode circuit wiring layer. The second and third upper ones of the conductive layers were anode circuit wiring layers for controlling the thirteen light source groups. The fourth one of the conductive layers was a heat diffusion layer that was entirely formed of solid filling for improving uniform brightness performance. A base material layer with the heat conductivity of 0.5 W/mK was employed.

As a metal support plate, an aluminum plate with the width of 10 mm, the thickness of 3 mm, and the length of 54 cm was used.

The flexible printed wiring board and the metal support plate were bonded to each other with an adhesive layer having the heat conductivity of 0.2 W/mK and the thickness of 30 μm. The adhesive layer was formed using epoxy based adhesive.

A comparative light source unit was prepared and, in this light source unit, only an adhesive layer was configured differently from the above-described adhesive layer. In the comparative light source unit, the flexible printed wiring board and the metal support plate were bonded to each other with an adhesive layer having the heat conductivity of 50 W/mK and the thickness of 30 μm. The adhesive layer was formed using silver paste.

Some of the light source groups were illuminated locally and the temperature distribution in the light source groups were viewed through a thermo viewer. In the light source unit using the adhesive having the heat conductivity of 0.2 W/mK, the average temperature was comparatively high and the temperature difference among the LEDs was comparatively small. In this light source unit, it was confirmed that the flexible printed wiring board effectively decreased unevenness in the temperature distribution in the flexible printed wiring board.

In contrast, in the comparative light source unit employing the adhesive having the heat conductivity of 50 W/mK, the average temperature was comparatively low and the temperature difference among the LEDs was comparatively great. In this light source unit, it was confirmed that the brightness of the LEDs that were switched from the OFF state to the ON state was higher than the brightness of the LEDs that were maintained continuously in the ON state.

As a result, it has been confirmed that, by employing the configuration according to the present invention, uniform brightness in the light source groups and improved heat dissipation performance are achieved effectively.

1. A light source unit comprising
one or more groups of light sources, each of the light source groups being configured by one or more light sources, the light source unit performing ON/OFF control separately on the respective light source groups or on the respective light sources;
a flexible printed wiring board formed by laminating one or more conductive layers on a flexible base material layer, the flexible printed wiring board having a first surface and a second surface located at the opposite side to the first surface, wherein the light source groups are mounted on the first surface of the flexible printed wiring board; and
a metal support plate attached to the second surface of the flexible printed wiring board with an adhesive layer, the metal support plate being a base of the light source unit,
wherein a heat conductivity in the adhesive layer in the vertical direction is lower than a heat conductivity in the base material layer of the flexible printed wiring board in the vertical direction.

2. The light source unit according to claim 1, wherein for any one of the light source groups including a plurality of light sources, the respective light sources can be subjected to the ON/OFF control separately from one light source to another.

3. The light source unit according to claim 1, wherein the heat conductivity in the adhesive layer in the vertical direction is set to 30 to 80% of the heat conductivity in the base material layer of the flexible printed wiring board in the vertical direction.

4. The light source unit according to claim 1, wherein each of the light sources includes a light emitting diode.

5. The light source unit according to claim 1, wherein
the conductive layers are formed by a plurality of copper film layers,
at least one of the conducive conductive layers is electrically disconnected from the other components and functions as a heat diffusion layer for diffusing heat produced by the light sources in operation into the flexible printed wiring board.

6. A backlight unit comprising a light source unit, the light source unit including:
one or more groups of light sources, each of the light source groups being configured by one or more light sources, the light source unit performing ON/OFF control separately on the respective light source groups or on the respective light sources;
a flexible printed wiring board formed by laminating one or more conductive layers on a flexible base material layer, the flexible printed wiring board having a first surface and a second surface located at the opposite side to the first surface, wherein the light source groups are mounted on the first surface of the flexible printed wiring board; and
a metal support plate attached to the second surface of the flexible printed wiring board with an adhesive layer, the metal support plate being a base of the light source unit,
wherein a heat conductivity in the adhesive layer in the vertical direction is lower than a heat conductivity in the base material layer of the flexible printed wiring board in the vertical direction.

7. A flat panel display apparatus comprising a backlight unit having a light source unit, the light source unit including:
one or more groups of light sources, each of the light source groups being configured by one or more light sources, the light source unit performing ON/OFF control separately on the respective light source groups or on the respective light sources;
a flexible printed wiring board formed by laminating one or more conductive layers on a flexible base material layer, the flexible printed wiring board having a first surface and a second surface located at the opposite side to the first surface, wherein the light source groups are mounted on the first surface of the flexible printed wiring board; and
a metal support plate attached to the second surface of the flexible printed wiring board with an adhesive layer, the metal support plate being a base of the light source unit,
wherein a heat conductivity in the adhesive layer in the vertical direction is lower than a heat conductivity in the base material layer of the flexible printed wiring board in the vertical direction.
